(19) United States
(12) Patent Application Publication
(10) Pub. No.: US 2013/0269958 A1
(43) Pub. Date: Oct. 17, 2013

(54) FLUORINATED OXIRANES AS FIRE EXTINGUISHING COMPOSITIONS AND METHODS OF EXTINGUISHING FIRES THEREWITH

(71) Applicants: Zhongxing Zhang, Woodbury, MN (US); Richard M. Minday, Stillwater, MN (US); John G. Owens, Woodbury, MN (US); Paul E. Rivers, Minneapolis, MN (US)

(72) Inventors: Zhongxing Zhang, Woodbury, MN (US); Richard M. Minday, Stillwater, MN (US); John G. Owens, Woodbury, MN (US); Paul E. Rivers, Minneapolis, MN (US)

(21) Appl. No.: 13/995,371

(22) PCT Filed: Jan. 9, 2012
(86) PCT No.: PCT/US12/20585

§ 371 Date: Jun. 18, 2013

Related U.S. Application Data
(60) Provisional application No. 61/431,119, filed on Jan. 10, 2011.

(51) Int. Cl. A62D 1/00; A62C 2/00

(52) U.S. Cl. CPC A62D 1/00; A62C 2/00
USPC 169/47; 252/2

(57) ABSTRACT

Fire extinguishing compositions and methods for extinguishing, controlling, or preventing fires are described wherein the extinguishing agent includes a fluorinated oxirane alone, or in admixture with a co-extinguishing agent selected from hydrofluorocarbons, hydrochlorofluorocarbons, perfluorocarbons, perfluoropolyethers, hydrofluoroethers, hydrofluoropolyethers, chlorofluorocarbons, bromofluorocarbons, bromochlorofluorocarbons, iodofluorocarbons, hydrobromofluorocarbons, fluorinated ketones, hydrobromocarbons, fluorinated olefins, hydrofluoroolefins, fluorinated sulfones, fluorinated vinylethers, and mixtures thereof. Also described are methods of preventing or extinguishing fires by introducing these compositions into an air-containing enclosed area and maintaining the composition in an amount sufficient to suppress combustion of combustible material in that enclosed area.

### FIELD

This invention relates to fire extinguishing compositions and methods for extinguishing, controlling or preventing fires.

### BACKGROUND

Various agents and methods of fire extinguishing are known and can be selected for a particular fire, depending upon its size and location, the type of combustible materials involved, etc. Halogenated hydrocarbon fire extinguishing agents have traditionally been utilized in flooding applications protecting fixed enclosures (e.g., computer rooms, storage vaults, telecommunications switching gear rooms, libraries, document archives, or petroleum pipeline pumping stations), or in streaming applications requiring rapid extinguishing (e.g., military flight lines, commercial hand-held extinguishers, or fixed system local applications). Such extinguishing agents are not only effective but, unlike water, also function as “clean extinguishing agents,” causing little, if any, damage to the enclosure or its contents.

The most commonly-used halogenated hydrocarbon extinguishing agents have been bromine-containing compounds, e.g., bromotrifluoromethane (CF₃Br, HALON 1301) and bromochlorodifluoromethane (CF₂ClBr, HALON 1211). Such bromine-containing halocarbons are highly effective in extinguishing fires and can be dispensed either from portable streaming equipment or from an automatic room flooding system activated either manually or by some method of fire detection. However, these compounds have been linked to ozone depletion. The Montreal Protocol and its attendant amendments have mandated that HALON 1211 and 1301 production be discontinued (see, e.g., P. S. Zurer, “Looming Ban on Production of CFCs, Halons Spurs Switch to Substitutes,” Chemical & Engineering News, Vol. 71, Issue 46, page 12, Nov. 15, 1993).

### SUMMARY

Thus, there has developed a need in the art for substitutes or replacements for the commonly-used, bromine-containing fire extinguishing agents. Such substitutes should have a low ozone depletion potential; should have the ability to extinguish, control, or prevent fires or flames, e.g., Class A (trash, wood, or paper), Class B (flammable liquids or greases), and/or Class C (electrical equipment) fires; and should be “clean extinguishing agents,” i.e., be electrically non-conducting, volatile or gaseous, and leave no residue. Substitutes should also be low in toxicity, not form flammable mixtures in air, have acceptable thermal and chemical stability for use in extinguishing applications, and have short atmospheric lifetimes and low global warming potentials. Various different fluorinated hydrocarbons have been suggested for use as fire extinguishing agents.

There is also a need for fire extinguishing agents that have excellent fire extinguishing properties and work at lower concentrations than fluorinated hydrocarbons. There is a need for fire extinguishing agents that have low toxicity and are non-hazardous. Finally, there is a need for fire extinguishing agents that can be readily manufactured.

In one aspect, a method of extinguishing a fire is provided that includes applying to the fire at least one non-flammable composition that includes a fluorinated oxirane compound; and suppressing the fire. The fluorinated oxirane compound can contain substantially no hydrogen atoms bonded to carbon atoms and can have a boiling point in a range of from about −10° C. to about 150° C. The non-flammable composition can further include at least one co-extinguishing agent selected from the group consisting of hydrofluorocarbons, hydrochlorofluorocarbons, perfluorocarbons, perfluoropolyethers, hydrofluoroethers, hydrofluoropolyethers, chlorofluorocarbons, bromofluorocarbons, bromochlorofluorocarbons, iodofluorocarbons, hydrobromofluorocarbons, fluorinated ketones, hydrobromocarbons, fluorinated olefins, hydrofluoroolefins, fluorinated sulfones, fluorinated vinylethers, and mixtures thereof.

In another aspect, a fire extinguishing composition is provided that includes (a) a fluorinated oxirane compound; and (b) at least one co-extinguishing agent selected from the group consisting of hydrofluorocarbons, hydrochlorofluorocarbons, perfluorocarbons, perfluoropolyethers, hydrofluoroethers, hydrofluoropolyethers, chlorofluorocarbons, bromofluorocarbons, bromochlorofluorocarbons, iodofluorocarbons, hydrobromofluorocarbons, fluorinated ketones, hydrobromocarbons, fluorinated olefins, hydrofluoroolefins, fluorinated sulfones, fluorinated vinylethers, and mixtures thereof, wherein (a) and (b) are present in an amount sufficient to suppress or extinguish a fire. (a) and (b) can be in a weight ratio of from about 9:1 to about 1:9.

In yet another aspect, a method of preventing fires or deflagration in an air-containing enclosed area containing combustible materials is provided that includes introducing into said area a non-flammable extinguishing composition comprising a fluorinated oxirane compound and maintaining said composition in an amount sufficient to suppress combustion of combustible materials in the enclosed area.

The fluorinated oxirane compounds used in the provided compositions and methods are surprisingly effective in extinguishing fires or flames while leaving no residue (i.e., function as clean extinguishing agents). These compounds can be low in toxicity and flammability, can have no or very low ozone depletion potentials, and can have short atmospheric lifetimes and low global warming potentials relative to bromofluorocarbons, bromochlorofluorocarbons, and many substitutes thereof (e.g., hydrochlorofluorocarbons, hydrofluorocarbons, and perfluorocarbons). Since the compounds exhibit good extinguishing capabilities and are also environmentally acceptable, they satisfy the need for substitutes or replacements for the commonly-used bromine-containing fire extinguishing agents which have been linked to the destruction of the earth's ozone layer.

In the present disclosure:

“fluorinated” refers to hydrocarbon compounds that have one or more C—H bonds replaced by C—F bonds;

“oxirane” refers to a substituted hydrocarbon that contains at least one epoxy group; and

“perfluorinated” refers to hydrocarbon compounds that have substantially all of their C—H bonds replaced by C—F bonds.

The provided fire extinguishing compositions (that include fluorinated olefins) and methods for extinguishing, controlling, or preventing fires can be used as replacements for commonly-used, bromine-containing fire extinguishing agents. They can cleanly (with no residue from the extinguishant) extinguish or suppress fires of Class A, Class B or Class C types. They are not electrically-conducting, or are highly volatile and they form nonflammable mixtures in air. Additionally, fluorinated oxirane compounds have good thermal and chemical stability.

The above summary is not intended to describe each disclosed embodiment of every implementation of the present invention. The detailed description which follows more particularly exemplify illustrative embodiments.

### DETAILED DESCRIPTION

In the following description, it is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Compounds that can be utilized in the provided processes and compositions include fluorinated oxirane compounds. The provided compounds can be utilized alone, in combination with one another, or in combination with other known extinguishing agents (e.g., hydrofluorocarbons, hydrochlorofluorocarbons, perfluorocarbons, perfluoropolyethers, hydrofluoroethers, hydrofluoropolyethers, chlorofluorocarbons, bromofluorocarbons, bromochlorofluorocarbons, iodofluorocarbons, hydrobromofluorocarbons, fluorinated ketones, hydrobromocarbons, fluorinated olefins, hydrofluoroolefins, fluorinated sulfones, fluorinated vinylethers, and mixtures thereof). The provided compounds can be liquids or gases under ambient conditions of temperature and pressure, but are typically utilized for extinguishing in either the liquid or the vapor state (or both).

Fluorinated oxiranes useful in the provided compositions and processes can be oxiranes that have a carbon backbone which is fully fluorinated (perfluorinated), i.e., substantially all of the hydrogen atoms in the carbon backbone have been replaced with fluorine or oxiranes that can have a carbon backbone which is fully fluorinated except for up to 3, optionally up to 2 hydrogen atoms, up to three, optionally two halogen atoms selected from chlorine, bromine and/or iodine atoms or a combination thereof. Fire suppression performance can be compromised when too many hydrogen atoms are present on the carbon backbone.

The provided fluorinated oxiranes are derived from fluorinated olefins that have been oxidized with epoxidizing agents. In the provided fluorinated oxirane compositions the carbon backbone includes the whole carbon framework including the longest hydrocarbon chain (main chain) and any carbon chains branching off of the main chain. In addition, there can be one or more catenated heteroatoms interrupting the carbon backbone such as oxygen, nitrogen, or sulfur atoms, for example ether or hexavalent sulfur functionalities. The catenated heteroatoms are typically not directly bonded to the oxirane ring. In these cases the carbon backbone includes the heteroatoms and the carbon framework attached to the heteroatom.

Typically, the majority of halogen atoms attached to the carbon backbone are fluorine; most typically, substantially all of the halogen atoms are fluorine so that the oxirane is a perfluorinated oxirane. The provided fluorinated oxiranes can have a total of 4 to 9 carbon atoms. Representative examples of fluorinated oxirane compounds suitable for use in the provided processes and compositions include 2,3-difluoro-2,3-bis-trifluoromethyl-oxirane, 2,2,3-trifluoro-3-pentafluoroethyl-oxirane, 2,3-difluoro-2-(1,2,2,2-tetrafluoro-1-trifluoromethyl-ethyl)-3-trifluoromethyl-oxirane, 2-fluoro-2-pentafluoroethyl-3,3-bis-trifluoromethyl-oxirane, 1,2,2,3,3,4,4,5,5,6-decafluoro-7-oxa-bicyclo[4.1.0]heptane, 2,3-difluoro-2-trifluoromethyl-3-pentafluoroethyl-oxirane, 2,3-difluoro-2-nonafluorobutyl-3-trifluoromethyl-oxirane, 2,3-difluoro-2-heptafluoropropyl-3-pentafluoroethyl-oxirane, 2-fluoro-3-pentafluoroethyl-2,3-bis-trifluoromethyl-oxirane, 2,3-bis-pentafluoroethyl-2,3-bistrifluoromethyl-oxirane, 2,3-bis-trifluoromethyl-oxirane, 2-pentafluoroethyl-3-trifluoromethyl-oxirane, 2-(1,2,2,2-tetrafluoro-1-trifluoromethyl-ethyl)-3-trifluoromethyl-oxirane, 2-nonafluorobutyl-3-pentafluoroethyl-oxirane, 2-fluoro-2-trifluoromethyl-oxirane, 2,2-bis-trifluoromethyl-oxirane, 2-fluoro-3-trifluoromethyl-oxirane and oxiranes of HFP trimer including 2-pentafluoroethyl-2-(1,2,2,2-tetrafluoro-1-trifluoromethyl-ethyl)-3,3-bis-trifluoromethyl-oxirane, 2-fluoro-3,3-bis-(1,2,2,2-tetrafluoro-1-trifluoromethyl-ethyl)-2-trifluoromethyl-oxirane, 2-fluoro-3-heptafluoropropyl-2-(1,2,2,2-tetrafluoro-1-trifluoromethyl-ethyl)-3-trifluoromethyl-oxirane and 2-(1,2,2,3,3,3-hexafluoro-1-trifluoromethyl-propyl)-2,3,3-tris-trifluoromethyl-oxirane.

The provided fluorinated oxirane compounds can be prepared by epoxidation of the corresponding fluorinated olefin using an oxidizing agent such as sodium hypochlorite, hydrogen peroxide or other well known epoxidizing agent such as peroxycarboxylic acids such as meta-chloroperoxybenzoic acid or peracetic acid. The fluorinated olefinic precursors can be directly available as, for example, in the cases of 1,1,1,2,3,4,4,4-octafluoro-but-2-ene (for making 2,3-difluoro-2,3-bis-trifluoromethyl oxirane), 1,1,1,2,3,4,4,5,5,5-decafluoro-pent-2-ene or 1,2,3,3,4,4,5,5,6,6 decafluoro-cyclohexene (for making 1,2,2,3,3,4,4,5,5,6-decafluoro-7-oxa-bicyclo[4.1.0]heptane). Other useful fluorinated olefinic precursors can include hexafluoropropene (HFP) oligomers such as dimers and trimers of tetrafluoroethylene (TFE) oligomers. The HFP oligomers can be prepared by contacting 1,1,2,3,3,3-hexafluoro-1-propene (hexafluoropropene) with a catalyst or mixture of catalysts selected from the group consisting of cyanide, cyanate, and thiocyanate salts of alkali metals, quaternary ammonium, and quaternary phosphonium in the presence of polar, aprotic solvents such as, for example, acetonitrile. The preparation of these HFP oligomers is disclosed, for example, in U.S. Pat. No. 5,254,774 (Prokop). Useful oligomers include HFP trimers or HFP dimers. HFP dimers include a mixture of cis- and trans-isomers of perfluoro-4-methyl-2-pentene as indicated in Table 1 in the Example section below. HFP trimers include a mixture of isomers of C₉F₁₈. This mixture has six main components that are also listed in Table 1 in the Example section.

The provided fluorinated oxirane compounds can have a boiling point in a range of from about −10° C. to about 150° C. In some embodiments, the fluorinated oxirane compounds can have a boiling point in the range of from about 0° C. to about 55° C. Some exemplary materials and their boiling point ranges are disclosed in the Examples section below.

The provided fire extinguishing method can be carried out by introducing a non-flammable extinguishing composition comprising at least one fluorinated oxirane compound to a fire or flame. The fluorinated oxirane(s) can be utilized alone or in a mixture with each other or with other commonly used clean extinguishing agents, e.g., hydrofluorocarbons, hydrochlorofluorocarbons, perfluorocarbons, perfluoropolyethers, hydrofluoroethers, hydrofluoropolyethers, chlorofluorocarbons, bromofluorocarbons, bromochlorofluorocarbons, hydrobromocarbons, iodofluorocarbons, fluorinated ketones, hydrofluorocarbons, hydrochlorofluorocarbons, perfluorocarbons, perfluoropolyethers, hydrofluoroethers, hydrofluoropolyethers, chlorofluorocarbons, bromofluorocarbons, bromochlorofluorocarbons, iodofluorocarbons, hydrobromofluorocarbons, fluorinated ketones, hydrobromocarbons, fluorinated olefins, hydrofluoroolefins, fluorinated sulfones, fluorinated vinylethers, and mixtures thereof.

Such co-extinguishing agents can be chosen to enhance the extinguishing capabilities or modify the physical properties (e.g., modify the rate of introduction by serving as a propellant) of an extinguishing composition for a particular type (or size or location) of fire and can preferably be utilized in ratios (of co-extinguishing agent to fluorinated oxirane compound(s)) such that the resulting composition does not form flammable mixtures in air. Typically, the extinguishing mixture contains from about 10-90% by weight of at least one fluorinated oxirane and from about 90-10% by weight of at least one co-extinguishing agent. The fluorinated oxirane compound(s) used in the composition can have boiling points in the range of from about −10° C. to about 150° C.

The provided extinguishing composition can typically be used in either the gaseous or the liquid state (or both), and any of the known techniques for introducing the composition to a fire can be utilized. For example, the composition can be introduced by streaming, e.g., using conventional portable (or fixed) fire extinguishing equipment, by misting, or by flooding, e.g., by releasing (using appropriate piping, valves, and controls) the composition into an enclosed space surrounding a fire or hazard. The provided composition can optionally be combined with inert propellant, e.g., nitrogen, argon, or carbon dioxide, to increase the rate of discharge of the composition from the streaming or flooding equipment utilized. When the composition is to be introduced by streaming or local application, fluorinated oxirane compound(s) having boiling points in the range of from about 20° C. to about 150° C. (especially fluorinated oxirane compounds which are liquid under ambient conditions) can be utilized. When the composition is to be introduced by misting, fluorinated oxirane compound(s) having boiling points in the range of from about 20° C. to about 150° C. can be utilized. And, when the composition is to be introduced by flooding, fluorinated oxirane compound(s) having boiling points in the range of from about −10° C. to about 75° C. are generally utilized.

The extinguishing composition can be introduced to a fire or flame in an amount sufficient to extinguish the fire or flame. One skilled in the art will recognize that the amount of extinguishing composition needed to extinguish a particular fire will depend upon the nature and extent of the hazard. When the extinguishing composition is to be introduced by flooding, cup burner test data (e.g., of the type described in the Examples, infra) can be useful in determining the amount or concentration of extinguishing composition required to extinguish a particular type and size of fire. Useful cup burner tests include, but are not limited to, ISO 14520-1: 2006 Annex B “Determination of Flame-extinguishing Concentration of Gaseous Extinguishants by the Cupburner Method.” A Micro-Cup Burner Test, such as the one disclosed in the Examples presented herein, can also be useful for determining the amount or concentration of extinguishing composition for a particular fire.

The provided fire extinguishing composition can include (a) at least one fluorinated oxirane compound; and (b) at least one co-extinguishing agent selected from the group consisting of hydrofluorocarbons, hydrochlorofluorocarbons, perfluorocarbons, perfluoropolyethers, hydrofluoroethers, hydrofluoropolyethers, chlorofluorocarbons, bromofluorocarbons, bromochlorofluorocarbons, iodofluorocarbons, hydrobromofluorocarbons, fluorinated ketones, hydrobromocarbons, fluorinated olefins, hydrofluoroolefins, fluorinated sulfones, fluorinated vinylethers, and mixtures thereof. Representative examples of co-extinguishing agents which can be used in the extinguishing composition include CF₃CH₂CF₃, C₅F₁₁H, C₆F₁₃H, C₄F₉H, CF₃CFHCFHCF₂CF₃, H(CF₂)₄H, CF₃H, C₂F₅H, CF₃CFHCF₃, CF₃CF₂CF₂H, CF₃CHCl₂, CF₃CHClF, CF₃CHF₂, CF₄, C₂F₆, C₃F₈, C₄F₁₀, C₆F₁₄, C₃F₇OCH₃, C₄F₉OCH₃, F(C₃F₆O)CF₂H, F(C₃F₆O)₂CF₂H, HCF₂OCF₂CF₂OCF₂H, HCF₂O(CF₂CF₂O)₂CF₂H, HCF₂O(CF₂O)ₓ(CF₂CF₂O)_{y}CF₂H, wherein x, and y, independent can be from 0-3, but the sum of x an y is greater than zero, C₂F₅Cl, CF₃Br, CF₂ClBr, CF₃I, CF₂HBr, n-C₃H₇Br, and CF₂BrCF₂Br. Representative examples of fluorinated ketone compounds suitable for use in the processes and compositions of the invention include CF₃CF₂C(O)CF(CF₃)₂, (CF₃)₂CFC(O)CF(CF₃)₂, CF₃(CF₂)₂C(O)CF(CF₃)₂, CF₃(CF₂)₃C(O)CF(CF₃)₂, CF₃(CF₂)₅C(O)CF₃, CF₃CF₂C(O)CF₂CF₂CF₃, CF₃C(O)CF(CF₃)₂ and perfluorocyclohexanone. Other useful fluorinated ketone co-extinguishants are disclosed, for example, in U.S. Pat. No. 6,478,979 (Rivers et al.). The weight ratio of co-extinguishing agent to fluorinated oxirane may vary from about 9:1 to about 1:9.

Yet another co-application process utilizing fluorinated oxiranes is the process where the fluorinated oxirane is super-pressurized upon activation of a manual hand-held extinguisher or a fixed system using an inert off-gas generated by the rapid burning of an energetic material such as glycidyl azide polymer. In addition, rapid burning of an energetic material such as glycidyl azide polymer that yields a hot gas can be used to heat and gasify a provided liquid fluorinated oxirane or other liquid fire extinguishing agent to make it easier to disperse. Furthermore, an unheated inert gas (e.g., from rapid burning of an energetic material) might be used as to propel the provided liquid fluorinated oxiranes or other liquid fire extinguishing agents to facilitate dispersal.

The above-described fluorinated oxirane compounds can be useful not only in controlling and extinguishing fires but also in preventing the combustible material from igniting. A process for preventing fires or deflagration in an air-containing, enclosed area which contains combustible materials of the self-sustaining or non-self-sustaining type is also provided. The provided process includes the step of introducing into an air-containing, enclosed area a non-flammable extinguishing composition which is essentially gaseous, i.e., gaseous or in the form of a mist, under use conditions and which comprises at least one fluorinated oxirane compound containing to up to three, optionally up to two hydrogen atoms, up to three, optionally two halogen atoms selected from chlorine, bromine and/or iodine atoms or a combination thereof selected from chlorine, bromine, iodine, and a mixture thereof, and optionally containing additional catenated heteroatoms. The composition is typically introduced and maintained in an amount sufficient to impart to the air in the enclosed area a heat capacity per mole of total oxygen present that will suppress combustion of combustible materials in the enclosed area. The fluorinated oxirane compounds useful in the process are those described above. Introduction of the extinguishing composition can generally be carried out by flooding or misting, e.g., by releasing (using appropriate piping, valves, and controls) the composition into an enclosed space surrounding a fire. However, any of the known methods of introduction can be utilized provided that appropriate quantities of the composition are metered into the enclosed area at appropriate intervals. Inert propellants, such as those propellants generated by decomposition of energetic materials such as glycidyl azide polymers, can optionally be used to increase the rate of introduction.

For fire prevention, compositions that include fluorinated oxirane compound(s) (and any co-extinguishing agent(s) utilized) can be chosen so as to provide an extinguishing composition that is essentially gaseous under use conditions. Typical compound(s) have boiling points in the range of from about −10° C. to about 150° C. The composition is introduced and maintained in an amount sufficient to impart to the air in the enclosed area a heat capacity per mole of total oxygen present that will suppress combustion of combustible materials in the enclosed area. The minimum heat capacity required to suppress combustion varies with the combustibility of the particular flammable materials present in the enclosed area. Combustibility varies according to chemical composition and according to physical properties such as surface area relative to volume, porosity, etc.

The provided fire prevention method can be used to eliminate the combustion-sustaining properties of air and to thereby suppress the combustion of flammable materials (e.g., paper, cloth, wood, flammable liquids, and plastic items). The method can be used continuously if a threat of fire always exists or can be used as an emergency measure if a threat of fire or deflagration develops.

Objects and advantages of this invention are further illustrated by the following examples, but the particular materials and amounts thereof recited in these examples, as well as other conditions and details, should not be construed to unduly limit this invention.

### EXAMPLES

TABLE 1
Materials

| Chemical | Description | Source |
|---|---|---|
| 1,1,1,2,3,4,4,4-octafluoro- | 2 Isomers; | Zhejiang Juhua Co., |
| but-2-ene | 85% perfluoro-2-butene and | LTD.Fluor-Polymeric |
| | 15% perfluoro-1-butene | Plant, Zhejiang, China |
| 1,1,1,2,3,4,5,5,5- nonafluoro-4- trifluoromethyl-pent-2-ene | HFP Dimer 2 isomers; 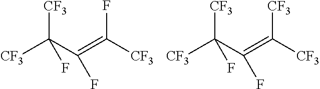 [SMILES: F/C(=C(/F)C(F)(C(F)(F)F)C(F)(F)F)C(F)(F)F ; FC(=C(C(F)(F)F)C(F)(F)F)C(F)(C(F)(F)F)C(F)(F)F] | 3M Foam Additive FA- 188, 2M, St. Paul, MN. |
| 1,2,3,3,4,4,5,5,6,6 | 89.3%, 2.6% isomers | Available from Sigma- |
| decafluoro-cyclohexene | | Aldrich, St. Louis, MO. |
| HFP Trimer | HFP Trimer 6 Isomers; 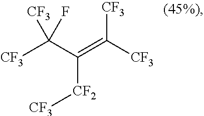 [SMILES: FC(F)(F)C(=C(C(F)(F)C(F)(F)F)C(F)(C(F)(F)F)C(F)(F)F)C(F)(F)F] | U.S. Pat. No. 5,254,774 |
| | 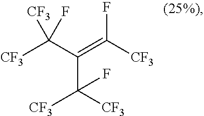 [SMILES: FC(=C(C(F)(C(F)(F)F)C(F)(F)F)C(F)(C(F)(F)F)C(F)(F)F)C(F)(F)F] | |
| | 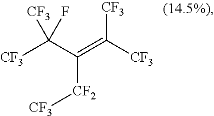 [SMILES: FC(F)(F)C(=C(C(F)(F)C(F)(F)F)C(F)(C(F)(F)F)C(F)(F)F)C(F)(F)F] | |
| | 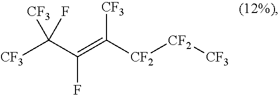 | |
| | 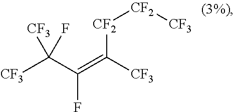 | |
| | 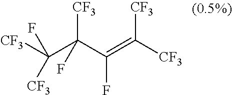 [SMILES: FC(=C(C(F)(F)F)C(F)(F)F)C(F)(C(F)(F)F)C(F)(C(F)(F)F)C(F)(F)F] | |
| Sodium Hydroxide | NaOH | GFS Chemicals, Inc., |
| | | Powell, OH |
| Sodium Hypochlorite | Na⁺[ClO]⁻ | Alfa Aesar, |
| | | Ward Hill, MA |
| Potassium Hydroxide | KOH | Sigma Aldrich, |
| | | Milwaukee, WI |
| Hydrogen Peroxide | H₂O₂ | GFS Chemicals, Inc., |
| | | Powell, OH |
| Acetonitrile | CH₃CN | Honeywell Burdick & |
| | | Jackson, Morristown, NJ |

### Test Methods

### Cup Burner Test

ISO 14520-1: 2006 Annex B “Determination of flame-extinguishing concentration of gaseous extinguishants by the cupburner method” was used for the determination of the cupburner extinguishing concentrations. Several modifications were necessary to introduce a liquid agent into the standard cupburner apparatus. A cylinder of 2,3-difluoro-2-(1,2,2,2-tertrafluoro-1-trifluoro-ethyl)-3-trifluoromethyl-oxirane (C₆F₁₂O) was held in a heated 90° C. bath to maintain a constant temperature in excess of the C₆F₁₂0 boiling point of 51° C. (123.8° F.). This was sufficient to produce an adequate agent vapor pressure to overcome any pressure of the airflow. All lines that contained saturated C₆F₁₂0 fluid vapor between the cylinder and the cupburner apparatus were heated using heating tape and a variable transformer to maintain a minimum temperature of 90° C. A metering valve with a vernier handle was used to introduce the saturated agent vapor into the air stream of the cupburner apparatus. The air/agent mixture was passed through a column filled with glass beads to ensure complete mixing before the gas sampling port. The mixed stream then entered the cupburner apparatus and the tests were run according to the ISO standard. All tests were run at a flow rate of 40 L/min, in accordance with Annex B.

The air flow rate was controlled with a Manostat 36-541-305 Rotameter. The rotameter was calibrated prior to testing with a BIOS DC-2 flow calibrator. The flow calibrator was connected inline after the stand-alone gas diffusion column and was not connected to the cupburner apparatus. After the correct gas flow was acquired the DC-2 was shutdown and removed from the line to insure the pressure entering the cupburner apparatus was consistent with the DC-2 measurements. The gas samples were obtained through the gas sampling port. Four 5 ml gas-tight syringes were used to pull samples from the gas sampling port. The syringes were purged three times with the agent and air mixture before each syringe extracted a final sample. Each syringe was then purged of all but a 1 ml sample volume. A FT-IR gas cell was purged with dry air and then evacuated before injecting a 1 ml sample. A PerkinElmer 1600 Series FT-IR was used to analyze samples from the three syringes. The cupburner was run at least five times in accordance with the standard. An average mass concentration was then calculated from three separate absorbance peaks on the IR spectrum, 1309 cm⁻¹, 1207 cm⁻¹ and 1168 cm⁻¹. Once the average mass concentration was determined the ideal gas law was used to calculate the ideal gas volume percent of C₆F₁₂O needed for extinguishment of a heptane fueled flame at 20° C. and 1 atm.

### Micro-Cup Burner Test

The Micro-Cup Burner Test is a laboratory test which measured the extinguishing ability of an agent based on the quantity of agent required to extinguish a fire under the following test conditions. The Micro-Cup Burner Test utilized a quartz concentric-tube laminar-diffusion flame burner (micro-cup burner, of similar design to the above-described cup apparatus) aligned vertically with all flows upward. A fuel, typically propane unless otherwise specified, flowed at 10.0 sccm (standard cubic centimeters per minute) through a 5-mm I.D. inner quartz tube which was centered in a 15-mm I.D. quartz chimney. The chimney extended 4.5 cm above the inner tube. Air flowed through the annular region between the inner tube and the chimney at 1000 sccm. Prior to the addition of extinguishing composition, a visually stable flame was supported on top of the inner tube, and the resulting combustion products flowed out through the chimney. An extinguishing composition to be evaluated was introduced into the air stream upstream of the burner. Liquid compositions were introduced by a syringe pump (which is calibrated to within 1%) and were volatilized in a heated trap. Gaseous compositions were introduced via a mass-flow controller to the air stream upstream from the burner. For consistency, the air-gaseous composition mixture then flowed through the heated trap prior to its introduction to the flame burner. All gas flows were maintained by electronic mass-flow controllers which are calibrated to within 2%. The fuel was ignited to produce a flame and was allowed to burn for 90 seconds. After 90 seconds, a specific flow rate of composition was introduced, and the time required for the flame to be extinguished was recorded. The reported extinguishing concentrations were the recorded volume % of extinguishing composition in air required to extinguish the flame within an average time of 30 seconds or less.

### Example 1

### Synthesis and purification of 2,3-difluoro-2,3,-bis-trifluoromethyl-oxirane

In a 2-liter stainless steel reactor fitted with a mixer and a cooling jacket, 500 grams of acetonitrile, 700 grams of sodium hypochlorite (14% by weight concentration), and 100 grams of 50% by weight sodium hydroxide were added. Upon being sealed, the reactor temperature was controlled at 0° C. using the reactor cooling jacket. Then 200 grams of perfluorobutene was gradually added to the reactor under strong mixing while controlling the reactor temperature at 0° C. After all the perfluoro-2-butene was added within about 2 hours, the reactor was heated to 20° C. to allow the product crude to vent from the reactor overhead and to be captured by a dry ice trap connected to the reactor overhead. 160 grams of the product crude was collected in the dry ice trap. The product crude was then purified in a 40-tray Oldshaw fractionation column with condenser being cooled to −40° C. The fractionation column was operated in such a way so that the reflux ratio (the distillate flow rate going back to the fractionation column to the distillate flow rate going to the product collection cylinder) was at 10:1. The final product was collected as the condensate when the head temperature in the fractionation column was between 0° C. and 2° C.

The 100 grams of the final product collected from the method above was analyzed by 376.3 MHz ¹⁹F-NMR spectra and identified as 2,3-difluoro-2,3,-bis-trifluoromethyl-oxirane with a purity of 99.4%.

Micro-cup burner testing indicated an average of 7.6% v/v of C₄F₈O in air was required to extinguish the flame within an average time of 30 seconds or less.

### Example 2

### Synthesis of 2,3-difluoro-2-(1,2,2,2-tetrafluoro-1-trifluoromethyl-ethyl)-3-trifluoromethyl-oxirane

In a 1.5 liter glass reactor fitted with a mixer and a cooling jacket, 400 grams of acetonitrile, 200 grams of 1,1,1,2,3,4,5,5,5-nonafluoro-4-trifluoromethyl-pent-2-ene and 150 grams of 50% potassium hydroxide were added. The reactor temperature was controlled at 0° C. using the reactor cooling jacket. Then 100 grams of 50% hydrogen peroxide was slowly added to the reactor under strong mixing while controlling the reactor temperature at 0° C. After all the hydrogen peroxide was added within about 2 hours, the mixer was turned off to allow the product crude to phase split from solvent and aqueous phases. 155 grams of the product crude was collected from the bottom product phase. The product crude was then washed with 200 grams of water to remove solvent acetonitrile and then purified in a 40-tray Oldshaw fractionation column with condenser being cooled to 15° C. The fractionation column was operated in such a way so that the reflux ratio (the distillate flow rate going back to the fractionation column to the distillate flow rate going to the product collection cylinder) was at 10:1. The final product was collected as the condensate when the head temperature in the fractionation column was between 52° C. and 53° C.

The 90 grams of the final product collected from the method above was analyzed by 376.3 MHz ¹⁹F-NMR spectra and identified as a mixture of 2,3-difluoro-2-(1,2,2,2-tetrafluoro-1-trifluoro-methyl-ethyl)-3-trifluoromethyl-oxirane, 95.8% and 2.2% of 2-fluoro-2-pentafluoroethyl-3,3-bis-trifluoromethyl-oxirane.

Cup burner testing indicated an average of 4.19% v/v of C₆F₁₂0 in air was required to extinguish a heptane fueled flame.

### Example 3

### Oxirane Synthesis and Purification of 1,2,2,3,3,4,4,5,5,6-decafluoro-7-oxa-bicyclo[4.1.0]heptane

In a 1.5 liter glass reactor fitted with a mixer and a cooling jacket, 400 grams of acetonitrile, 200 grams of 1,2,3,3,4,4,5,5,6,6-decafluoro-cyclohexene (89.3% purity) and 150 grams of 50% potassium hydroxide were added. The reactor temperature was controlled at 0° C. using the reactor cooling jacket. Then 100 grams of 50% hydrogen peroxide was slowly added to the reactor under strong mixing while controlling the reactor temperature at 0° C. After all the hydrogen peroxide was added within about 2 hours, the mixer was turned off to allow the product crude to phase split from solvent and aqueous phases. 100 grams of the product crude was collected from the bottom product phase. The product crude was then washed with 100 grams of water to remove solvent acetonitrile and then purified in a 40-tray Oldshaw fractionation column with condenser being cooled to 15° C. The fractionation column was operated in such a way that the reflux ratio (the distillate flow rate going back to the fractionation column to the distillate flow rate going to the product collection cylinder) was at 10:1. The final product was collected as the condensate when the head temperature in the fractionation column was between 47° C. and 55° C.

The 70 grams of the final product collected from the method above was analyzed by 376.3 MHz ¹⁹F-NMR spectra and identified as 1,2,2,3,3,4,4,5,5,6-decafluoro-7-oxa-bicyclo[4.1.0]heptane with a purity of 94.1% with an additional 2.6% isomers.

Micro-cup burner testing indicated an average of 6.0% v/v of C₆F₁₀0 in air was required to extinguish the flame within an average time of 30 seconds or less.

### Example 4

### C₉ Oxirane Synthesis and purification of HFP Trimer-oxirane (C₉F₁₈O)

In a 1.5 liter glass reactor fitted with a mixer and a cooling jacket, 400 grams of acetonitrile, 200 grams of HFP Trimer (C₉F₁₈), and 150 grams of 50% potassium hydroxide were added. The reactor temperature was controlled at 0° C. using the reactor cooling jacket. Then 100 grams of 50% hydrogen peroxide was slowly added to the reactor under strong mixing while controlling the reactor temperature between 0° C. and 20° C. After all the hydrogen peroxide was added within about 2 hours, the mixer was turned off to allow the product crude to phase split from solvent and aqueous phases. 180 grams of the product crude was collected from the bottom product phase. The product crude was then washed with 200 grams of water to remove solvent acetonitrile and then purified in a 40-tray Oldshaw fractionation column with condenser being cooled to 15° C. The fractionation column was operated in such a way so that the reflux ratio (the distillate flow rate going back to the fractionation column to the distillate flow rate going to the product collection cylinder) was at 10:1. The final product was collected as the condensate when the head temperature in the fractionation column was between 120° C. and 122° C.

The 150 grams of the final product collected from the method above was analyzed by 376.3 MHz ¹⁹F-NMR spectra and identified as oxiranes of HFP trimer (C₉F₁₈0) with 5 isomeric forms. The sum of all 5 isomers had a purity of 99.4%.

Micro-cup burner testing indicated an average of 4.8% v/v of C₉F₁₈0 in air was required to extinguish the flame within an average time of 30 seconds or less.

Following are exemplary embodiments of fluorinated oxiranes as fire extinguishing compositions and methods of extinguishing fires therewith, respectively, according to aspects of the present invention.

Embodiment 1 is a method of extinguishing a fire comprising: applying to the fire at least one non-flammable composition that includes a fluorinated oxirane compound containing at least one oxirane ring; and suppressing the fire.

Embodiment 2 is a method of extinguishing a fire according to embodiment 1, wherein the fluorinated oxirane compound contains substantially no hydrogen atoms bonded to carbon atoms.

Embodiment 3 is a method of extinguishing a fire according to embodiment 1,

wherein the non-flammable composition further comprises at least one co-extinguishing agent selected from the group consisting of hydrofluorocarbons, hydrochlorofluorocarbons, perfluorocarbons, perfluoropolyethers, hydrofluoroethers, hydrofluoropolyethers, chlorofluorocarbons, bromofluorocarbons, bromochlorofluorocarbons, iodofluorocarbons, hydrobromofluorocarbons, fluorinated ketones, hydrobromocarbons, fluorinated olefins, hydrofluoroolefins, fluorinated sulfones, fluorinated vinylethers, and mixtures thereof.

Embodiment 4 is a method of extinguishing a fire according to embodiment 1, wherein the fluorinated oxirane has a total of 4 to 9 carbon atoms.

Embodiment 5 is a method of extinguishing a fire according to embodiment 1, wherein the fluorinated oxirane compound has a boiling point in a range of from about −10° C. to about 150° C.

Embodiment 6 is a method of extinguishing a fire according to embodiment 5, wherein the fluorinated oxirane has a boiling point of from about 0° C. to about 55° C.

Embodiment 7 is a method of extinguishing a fire according to embodiment 1, wherein the fluorinated oxirane is at least one compound selected from the group consisting of 2,3-difluoro-2,3-bis-trifluoromethyl-oxirane, 2,2,3-trifluoro-3-pentafluoroethyl-oxirane, 2,3-difluoro-2-(1,2,2,2-tetrafluoro-1-trifluoromethyl-ethyl)-3-trifluoromethyl-oxirane, 2-fluoro-2-pentafluoroethyl-3,3-bis-trifluoromethyl-oxirane, 1,2,2,3,3,4,4,5,5,6-decafluoro-7-oxa-bicyclo[4.1.0]heptane, 2,3-difluoro-2-trifluoromethyl-3-pentafluoroethyl-oxirane, 2,3-difluoro-2-nonafluorobutyl-3-trifluoromethyl-oxirane, 2,3-difluoro-2-heptafluoropropyl-3-pentafluoroethyl-oxirane, 2-fluoro-3-pentafluoroethyl-2,3-bis-trifluoromethyl-oxirane, 2,3-bis-pentafluoroethyl-2,3-bistrifluoromethyl-oxirane, 2-pentafluoroethyl-2-(1,2,2,2-tetrafluoro-1-trifluoromethyl-ethyl)-3,3-bis-trifluoromethyl-oxirane, 2-fluoro-3,3-bis-(1,2,2,2-tetrafluoro-1-trifluoromethyl-ethyl)-2-trifluoromethyl-oxirane2-fluoro-3-heptafluoropropyl-2-(1,2,2,2-tetrafluoro-1-trifluoromethyl-ethyl)-3-trifluoromethyl-oxirane and 2-(1,2,2,3,3,3-hexafluoro-1-trifluoromethyl-propyl)-2,3,3-tris-trifluoromethyl-oxirane, and mixtures thereof.

Embodiment 8 is a method of extinguishing a fire according to embodiment 1, wherein the fluorinated oxirane compound comprises one or more catenated heteroatoms interrupting the carbon backbone selected from oxygen, nitrogen, or sulfur, wherein the catenated heteroatoms are not directly bonded to the oxirane ring of the fluorinated oxirane compound.

Embodiment 9 is a method of extinguishing a fire according to embodiment 1, wherein suppressing the fire comprises extinguishing the fire.

Embodiment 10 is a fire extinguishing composition comprising: (a) a fluorinated oxirane compound containing at least one oxirane ring; and (b) at least one co-extinguishing agent selected from the group consisting of hydrofluorocarbons, hydrochlorofluorocarbons, perfluorocarbons, perfluoropolyethers, hydrofluoroethers, hydrofluoropolyethers, chlorofluorocarbons, bromofluorocarbons, bromochlorofluorocarbons, iodofluorocarbons, hydrobromofluorocarbons, fluorinated ketones, hydrobromocarbons, fluorinated olefins, hydrofluoroolefins, fluorinated sulfones, fluorinated vinylethers, and mixtures thereof, wherein (a) and (b) are present in an amount sufficient to suppress or extinguish a fire.

Embodiment 11 is a fire extinguishing composition according to embodiment 10, wherein (a) and (b) are in a weight ratio of from about 9:1 to about 1:9.

Embodiment 12 is a fire extinguishing composition according to embodiment 10, wherein the fluorinated oxirane has a total of 4 to 9 carbon atoms.

Embodiment 13 is a fire extinguishing composition according to embodiment 10, wherein the fluorinated oxirane has a boiling point of from about −10° C. to about 150° C.

Embodiment 14 is a fire extinguishing composition according to embodiment 10, wherein the fluorinated oxirane compound comprises one or more catenated heteroatoms interrupting the carbon backbone selected from oxygen, nitrogen, or sulfur, wherein the catenated heteroatoms are not directly bonded to the oxirane ring of the fluorinated oxirane compound.

Embodiment 15 is a fire extinguishing composition according to embodiment 11, wherein the fluorinated oxirane is at least one compound selected from the group consisting of 2,3-difluoro-2,3-bis-trifluoromethyl-oxirane, 2,2,3-trifluoro-3-pentafluoroethyl-oxirane, 2,3-difluoro-2-(1,2,2,2-tetrafluoro-1-trifluoromethyl-ethyl)-3-trifluoromethyl-oxirane, 2-fluoro-2-pentafluoroethyl-3,3-bis-trifluoromethyl-oxirane, 1,2,2,3,3,4,4,5,5,6-decafluoro-7-oxa-bicyclo[4.1.0]heptane, 2,3-difluoro-2-trifluoromethyl-3-pentafluoroethyl-oxirane, 2,3-difluoro-2-nonafluorobutyl-3-trifluoromethyl-oxirane, 2,3-difluoro-2-heptafluoropropyl-3-pentafluoroethyl-oxirane, 2-fluoro-3-pentafluoroethyl-2,3-bis-trifluoromethyl-oxirane, 2,3-bis-pentafluoroethyl-2,3-bistrifluoromethyl-oxirane, 2-pentafluoroethyl-2-(1,2,2,2-tetrafluoro-1-trifluoromethyl-ethyl)-3,3-bis-trifluoromethyl-oxirane, 2-fluoro-3,3-bis-(1,2,2,2-tetrafluoro-1-trifluoromethyl-ethyl)-2-trifluoromethyl-oxirane2-fluoro-3-heptafluoropropyl-2-(1,2,2,2-tetrafluoro-1-trifluoromethyl-ethyl)-3-trifluoromethyl-oxirane and 2-(1,2,2,3,3,3-hexafluoro-1-trifluoromethyl-propyl)-2,3,3-tris-trifluoromethyl-oxirane, and mixtures thereof.

Embodiment 16 is a method of preventing fires or deflagration in an air-containing enclosed area containing combustible materials comprising: introducing into said area a non-flammable extinguishing composition comprising a fluorinated oxirane compound; and maintaining said composition in an amount sufficient to suppress combustion of combustible materials in the enclosed area.

Embodiment 17 is a method of preventing fires or deflagration in an air-containing enclosed area containing combustible materials according to embodiment 16, wherein the fluorinated oxirane compound has a boiling point in a range of from about −10° C. to about 150° C.

Embodiment 18 is a method of preventing fires or deflagration in an air-containing enclosed area containing combustible materials according to embodiment 16, wherein the fluorinated oxirane compound has a total of 4 to 9 carbon atoms.

Embodiment 19 is a method of preventing fires or deflagration in an air-containing enclosed area containing combustible materials according to embodiment 16, wherein the fluorinated oxirane compound is selected from the group consisting of 2,3-difluoro-2,3-bis-trifluoromethyl-oxirane, 2,2,3-trifluoro-3-pentafluoroethyl-oxirane, 2,3-difluoro-2-(1,2,2,2-tetrafluoro-1-trifluoromethyl-ethyl)-3-trifluoromethyl-oxirane, 2-fluoro-2-pentafluoroethyl-3,3-bis-trifluoromethyl-oxirane, 1,2,2,3,3,4,4,5,5,6-decafluoro-7-oxa-bicyclo[4.1.0]heptane, 2,3-difluoro-2-trifluoromethyl-3-pentafluoroethyl-oxirane, 2,3-difluoro-2-nonafluorobutyl-3-trifluoromethyl-oxirane, 2,3-difluoro-2-heptafluoropropyl-3-pentafluoroethyl-oxirane, 2-fluoro-3-pentafluoroethyl-2,3-bis-trifluoromethyl-oxirane, 2,3-bis-pentafluoroethyl-2,3-bistrifluoromethyl-oxirane, 2-pentafluoroethyl-2-(1,2,2,2-tetrafluoro-1-trifluoromethyl-ethyl)-3,3-bis-trifluoromethyl-oxirane, 2-fluoro-3,3-bis-(1,2,2,2-tetrafluoro-1-trifluoromethyl-ethyl)-2-trifluoromethyl-oxirane2-fluoro-3-heptafluoropropyl-2-(1,2,2,2-tetrafluoro-1-trifluoromethyl-ethyl)-3-trifluoromethyl-oxirane and 2-(1,2,2,3,3,3-hexafluoro-1-trifluoromethyl-propyl)-2,3,3-tris-trifluoromethyl-oxirane, and mixtures thereof.

Embodiment 20 is a method according to embodiment 16, wherein the composition further comprises at least one co-extinguishing agent selected from the group consisting of hydrofluorocarbons, hydrochlorofluorocarbons, perfluorocarbons, perfluoropolyethers, hydrofluoroethers, hydrofluoropolyethers, chlorofluorocarbons, bromofluorocarbons, bromochlorofluorocarbons, iodofluorocarbons, hydrobromofluorocarbons, fluorinated ketones, hydrobromocarbons, fluorinated olefins, hydrofluoroolefins, fluorinated sulfones, fluorinated vinylethers, and mixtures thereof.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited in this disclosure are herein incorporated by reference in their entirety.

1. A method of extinguishing a fire comprising:
applying to the fire at least one non-flammable composition that includes a fluorinated oxirane compound containing at least one oxirane ring; and
suppressing the fire;
wherein said fluorinated oxirane is utilized alone or in a mixture with other clean extinguishing agents,
wherein the fluorinated oxirane compound has a boiling point in a range of from about −10° C. to about 150° C.

2. A method of extinguishing a fire according to claim 1, wherein the fluorinated oxirane compound contains substantially no hydrogen atoms bonded to carbon atoms.

3. A method of extinguishing a fire according to claim 1, wherein the non-flammable composition further comprises at least one co-extinguishing agent selected from the group consisting of hydrofluorocarbons, hydrochlorofluorocarbons, perfluorocarbons, perfluoropolyethers, hydrofluoroethers, hydrofluoropolyethers, chlorofluorocarbons, bromofluorocarbons, bromochlorofluorocarbons, iodofluorocarbons, hydrobromofluorocarbons, fluorinated ketones, hydrobromocarbons, fluorinated olefins, hydrofluoroolefins, fluorinated sulfones, fluorinated vinylethers, and mixtures thereof.

4. A method of extinguishing a fire according to claim 1, wherein the fluorinated oxirane has a total of 4 to 9 carbon atoms.

5. (canceled)

6. A method of extinguishing a fire according to claim 1, wherein the fluorinated oxirane has a boiling point of from about 0° C. to about 55° C.

7. A method of extinguishing a fire according to claim 1, wherein the fluorinated oxirane is at least one compound selected from the group consisting of 2,3-difluoro-2,3-bis-trifluoromethyl-oxirane, 2,2,3-trifluoro-3-pentafluoroethyl-oxirane, 2,3-difluoro-2-(1,2,2,2-tetrafluoro-1-trifluoromethyl-ethyl)-3-trifluoromethyl-oxirane, 2-fluoro-2-pentafluoroethyl-3,3-bis-trifluoromethyl-oxirane, 1,2,2,3,3,4,4,5,5,6-decafluoro-7-oxa-bicyclo[4.1.0]heptane, 2,3-difluoro-2-trifluoromethyl-3-pentafluoroethyl-oxirane, 2,3-difluoro-2-nonafluorobutyl-3-trifluoromethyl-oxirane, 2,3-difluoro-2-heptafluoropropyl-3-pentafluoroethyl-oxirane, 2-fluoro-3-pentafluoroethyl-2,3-bis-trifluoromethyl-oxirane, 2,3-bis-pentafluoroethyl-2,3-bistrifluoromethyl-oxirane, 2-pentafluoroethyl-2-(1,2,2,2-tetrafluoro-1-trifluoromethyl-ethyl)-3,3-bis-trifluoromethyl-oxirane, 2-fluoro-3,3-bis-(1,2,2,2-tetrafluoro-1-trifluoromethyl-ethyl)-2-trifluoromethyl-oxirane2-fluoro-3-heptafluoropropyl-2-(1,2,2,2-tetrafluoro-1-trifluoromethyl-ethyl)-3-trifluoromethyl-oxirane and 2-(1,2,2,3,3,3-hexafluoro-1-trifluoromethyl-propyl)-2,3,3-tris-trifluoromethyl-oxirane, and mixtures thereof.

8. A method of extinguishing a fire according to claim 1, wherein the fluorinated oxirane compound comprises one or more catenated heteroatoms interrupting the carbon backbone selected from oxygen, nitrogen, or sulfur, wherein the catenated heteroatoms are not directly bonded to the oxirane ring of the fluorinated oxirane compound.

9. A method of extinguishing a fire according to claim 1, wherein suppressing the fire comprises extinguishing the fire.

10. A fire extinguishing composition comprising:
(a) a fluorinated oxirane compound containing at least one oxirane ring; and
(b) at least one co-extinguishing agent selected from the group consisting of hydrofluorocarbons, hydrochlorofluorocarbons, perfluorocarbons, perfluoropolyethers, hydrofluoroethers, hydrofluoropolyethers, chlorofluorocarbons, bromofluorocarbons, bromochlorofluorocarbons, iodofluorocarbons, hydrobromofluorocarbons, fluorinated ketones, hydrobromocarbons, fluorinated olefins, hydrofluoroolefins, fluorinated sulfones, fluorinated vinylethers, and mixtures thereof,
wherein (a) and (b) are present in an amount sufficient to suppress or extinguish a fire.

11. A fire extinguishing composition according to claim 10, wherein (a) and (b) are in a weight ratio of from about 9:1 to about 1:9.

12. A fire extinguishing composition according to claim 10, wherein the fluorinated oxirane has a total of 4 to 9 carbon atoms.

13. A fire extinguishing composition according to claim 10, wherein the fluorinated oxirane has a boiling point of from about −10° C. to about 150° C.

14. A fire extinguishing composition according to claim 10, wherein the fluorinated oxirane compound comprises one or more catenated heteroatoms interrupting the carbon backbone selected from oxygen, nitrogen, or sulfur, wherein the catenated heteroatoms are not directly bonded to the oxirane ring of the fluorinated oxirane compound.

15. A fire extinguishing composition according to claim 11, wherein the fluorinated oxirane is at least one compound selected from the group consisting of 2,3-difluoro-2,3-bis-trifluoromethyl-oxirane, 2,2,3-trifluoro-3-pentafluoroethyl-oxirane, 2,3-difluoro-2-(1,2,2,2-tetrafluoro-1-trifluoromethyl-ethyl)-3-trifluoromethyl-oxirane, 2-fluoro-2-pentafluoroethyl-3,3-bis-trifluoromethyl-oxirane, 1,2,2,3,3,4,4,5,5,6-decafluoro-7-oxa-bicyclo[4.1.0]heptane, 2,3-difluoro-2-trifluoromethyl-3-pentafluoroethyl-oxirane, 2,3-difluoro-2-nonafluorobutyl-3-trifluoromethyl-oxirane, 2,3-difluoro-2-heptafluoropropyl-3-pentafluoroethyl-oxirane, 2-fluoro-3-pentafluoroethyl-2,3-bis-trifluoromethyl-oxirane, 2,3-bis-pentafluoroethyl-2,3-bistrifluoromethyl-oxirane, 2-pentafluoroethyl-2-(1,2,2,2-tetrafluoro-1-trifluoromethyl-ethyl)-3,3-bis-trifluoromethyl-oxirane, 2-fluoro-3,3-bis-(1,2,2,2-tetrafluoro-1-trifluoromethyl-ethyl)-2-trifluoromethyl-oxirane2-fluoro-3-heptafluoropropyl-2-(1,2,2,2-tetrafluoro-1-trifluoromethyl-ethyl)-3-trifluoromethyl-oxirane and 2-(1,2,2,3,3,3-hexafluoro-1-trifluoromethyl-propyl)-2,3,3-tris-trifluoromethyl-oxirane, and mixtures thereof.

16. A method of preventing fires or deflagration in an air-containing enclosed area containing combustible materials comprising:
introducing into said area a non-flammable extinguishing composition comprising a fluorinated oxirane compound; and
maintaining said composition in an amount sufficient to suppress combustion of combustible materials in the enclosed area.

17. A method of preventing fires or deflagration in an air-containing enclosed area containing combustible materials according to claim 16, wherein the fluorinated oxirane compound has a boiling point in a range of from about −10° C. to about 150° C.

18. A method of preventing fires or deflagration in an air-containing enclosed area containing combustible materials according to claim 16, wherein the fluorinated oxirane compound has a total of 4 to 9 carbon atoms.

19. A method of preventing fires or deflagration in an air-containing enclosed area containing combustible materials according to claim 16, wherein the fluorinated oxirane compound is selected from the group consisting of 2,3-difluoro-2,3-bis-trifluoromethyl-oxirane, 2,2,3-trifluoro-3-pentafluoroethyl-oxirane, 2,3-difluoro-2-(1,2,2,2-tetrafluoro-1-trifluoromethyl-ethyl)-3-trifluoromethyl-oxirane, 2-fluoro-2-pentafluoroethyl-3,3-bis-trifluoromethyl-oxirane, 1,2,2,3,3,4,4,5,5,6-decafluoro-7-oxa-bicyclo[4.1.0]heptane, 2,3-difluoro-2-trifluoromethyl-3-pentafluoroethyl-oxirane, 2,3-difluoro-2-nonafluorobutyl-3-trifluoromethyl-oxirane, 2,3-difluoro-2-heptafluoropropyl-3-pentafluoroethyl-oxirane, 2-fluoro-3-pentafluoroethyl-2,3-bis-trifluoromethyl-oxirane, 2,3-bis-pentafluoroethyl-2,3-bistrifluoromethyl-oxirane, 2-pentafluoroethyl-2-(1,2,2,2-tetrafluoro-1-trifluoromethyl-ethyl)-3,3-bis-trifluoromethyl-oxirane, 2-fluoro-3,3-bis-(1,2,2,2-tetrafluoro-1-trifluoromethyl-ethyl)-2-trifluoromethyl-oxirane2-fluoro-3-heptafluoropropyl-2-(1,2,2,2-tetrafluoro-1-trifluoromethyl-ethyl)-3-trifluoromethyl-oxirane and 2-(1,2,2,3,3,3-hexafluoro-1-trifluoromethyl-propyl)-2,3,3-tris-trifluoromethyl-oxirane, and mixtures thereof.

20. A method according to claim 16, wherein the composition further comprises at least one co-extinguishing agent selected from the group consisting of hydrofluorocarbons, hydrochlorofluorocarbons, perfluorocarbons, perfluoropolyethers, hydrofluoroethers, hydrofluoropolyethers, chlorofluorocarbons, bromofluorocarbons, bromochlorofluorocarbons, iodofluorocarbons, hydrobromofluorocarbons, fluorinated ketones, hydrobromocarbons, fluorinated olefins, hydrofluoroolefins, fluorinated sulfones, fluorinated vinylethers, and mixtures thereof.
